(19) United States
(12) Patent Application Publication
(10) Pub. No.: US 2025/0286950 A1
(43) Pub. Date: Sep. 11, 2025

(54) SYSTEMS AND METHODS FOR IMPROVING CALL CENTER FEATURES USING GENERATIVE AI

(71) Applicant: The Toronto-Dominion Bank, Toronto (CA)

(72) Inventors: Hitesh BAJAJ, Duluth, GA (US); Milos DUNJIC, Oakville (CA); David Samuel TAX, Toronto (CA); Jonathan Joseph PRENDERGAST, West Chester, PA (US); Mohit SHARMA, Toronto (CA); Abhijit SINGHA HAZARI, Oakville (CA); Pranay GUPTA, Toronto (CA); Kushank RASTOGI, Toronto (CA); Thomas KELLY, Wenonah, NJ (US)

(73) Assignee: The Toronto-Dominion Bank, Toronto, ON (CA)

(21) Appl. No.: 18/601,412

(22) Filed: Mar. 11, 2024

(51) Int. Cl. H04M 3/436; G06N 3/0475; H04M 3/22; H04M 3/42

(52) U.S. Cl. CPC H04M 3/4365; G06N 3/0475; H04M 3/2218; H04M 3/42221

(57) ABSTRACT

The present disclosure relates to systems and methods for enhancing call center features using generative AI. There is provided a server computer system, comprising: a processor, a communications module coupled to the processor, and a memory coupled to the processor. The memory stores a playbook of a call center and instructions that, when executed, configure the processor to monitor a call in real-time during the call with a caller, identify, from the call, a caller issue in real-time using a trained machine learning model, obtain a response to the caller issue based on execution of a generative artificial intelligence (GenAI) model and the playbook stored in the memory, and implement the response during the call.

### TECHNICAL FIELD

The present application relates to call centers and, more particularly, to systems and methods for improving call center features using generative AI.

### BACKGROUND

Ideally, when calling a call center, a customer would be immediately connected to an agent with complete information and the requisite experience to provide direct assistance to the caller. However, that is often not possible or difficult, as call center playbooks can be long and complicated, there may be more callers than available agents, the agent may not have prior experience with the particular issue(s) of the caller, and/or the agent may not have all the requisite information immediately on hand. This may delay the caller from receiving their desired assistance in a timely fashion.

Meanwhile, generative artificial intelligence (GenAI) is an artificial intelligence that is capable of generating text, images, and other media from generative artificial intelligence models such as large language models, multi-modal large language models, neural networks, and the like. A GenAI model can learn patterns and structure of the training data input to the GenAI model during training, and then use what is learned during the training to generate new data with similar characteristics.

### BRIEF DESCRIPTION OF THE DRAWINGS

Embodiments are described in detail below, with reference to the following drawings:

FIG. 1 is a schematic operations diagram illustrating an operating environment of a system according to an example embodiment of the present disclosure;

FIG. 2 is a simplified schematic diagram showing components of an example computer device;

FIG. 3 is a high-level schematic diagram of an example computer system;

FIG. 4 shows a simplified organization of software components stored in a memory of the computer system of FIG. 3; and

FIG. 5 is a schematic diagram illustrating a generative artificial intelligence (GenAI) computing environment of the server computer system of FIG. 1 according to example embodiments;

FIG. 6 is a diagram illustrating processes for training a machine learning model according to example embodiments; and

FIG. 7 is a flowchart showing operations performed by the server computer system of FIG. 5 for enhancing call center features according to example embodiments.

Like reference numerals are used in the drawings to denote like elements and features.

### DETAILED DESCRIPTION

In one aspect of the present disclosure, there is provided a server computer system, comprising: a processor; a communications module coupled to the processor; and a memory coupled to the processor, the memory storing a playbook of a call center and instructions that, when executed, configure the processor to: monitor a call in real-time during the call with a caller; identify, from the call, a caller issue in real-time using a trained machine learning model; obtain a response to the caller issue based on execution of a generative artificial intelligence (GenAI) model and the playbook stored in the memory; and implement the response during the call.

In some implementations, the instructions further configure the processor to obtain a transcript of the call in real-time during the call, and identify the caller issue from the transcript of the call.

In some implementations, the server computer system further comprises a transcriber coupled to the processor, wherein the transcript of the call is obtained by the transcriber.

In some implementations, the instructions further configure the processor to train the GenAI model with other call center playbooks prior to the call.

In some implementations, the GenAI model is a large language model (LLM).

In some implementations, the instructions further configure the processor to obtain the response by: generating a prompt to the LLM, the prompt including the caller issue with reference to the playbook; and obtain an output from the LLM responsive to the prompt; and implement the response by providing the output via a user interface.

In some implementations, the output comprises a summary of a portion of the playbook related to the caller issue, and the prompt to the LLM is for generating the summary as the output.

In some implementations, the instructions further configure the processor to receive an authorization regarding an identity of the caller from an agent device.

In some implementations, the prompt further includes reference to account information associated with the identity of the caller.

In some implementations, the caller issue is a form of a question, the output comprises a reply to the question, and the prompt to the LLM is for generating the reply based on the playbook customized according to the account information.

In some implementations, the memory further stores prior call transcripts of the call center, wherein the prompt to the LLM is for identifying: the caller issue in one of the prior call transcripts, and a solution to the caller issue in the one of the prior call transcripts; and wherein the output comprises the solution.

In some implementations, the instructions further configure the processor to receive feedback about the solution via the user interface, retrain the GenAI model based on execution of the GenAI model on the caller issue, the solution, and the feedback, and store the retrained GenAI model in the memory.

In some implementations, the memory further stores call log data of the call center, the call log data comprising prior call transcripts of prior calls and metadata associated with the prior calls, wherein the instructions, when executed, further configure the processor to: obtain the response by: generating a prompt to the GenAI model, the prompt including the caller issue with reference to the playbook and the call log data, and obtain an output from the GenAI model responsive to the prompt; and implement the response based on the output.

In some implementations, the metadata comprises a call duration of each of the prior calls, wherein the prompt to the GenAI model is for identifying: the caller issue in one of the prior call transcripts, and the call duration of the prior call of the one of the prior call transcripts; wherein the output comprises an expected call duration of the call based on the call duration of the prior call of the one of the prior call transcripts; and wherein the instructions, when executed, further configure the processor to implement the response by placing the call in a call queue according to the expected call duration.

In some implementations, the prompt further includes account information associated with an identity of the caller, and wherein the expected call duration is further based on the account information of the caller.

In some implementations, the instructions further configure the processor to implement the response by routing the call to a particular agent based on the output.

In some implementations, the metadata comprises identification of an agent associated each of the prior calls, wherein the prompt to the GenAI model is for identifying: the caller issue in one of the prior call transcripts, and the identification of the agent associated with the prior call of the one of the prior call transcripts; wherein the output comprises the identification of the agent associated with the prior call of the one of the prior call transcripts; and wherein the instructions, when executed, further configure the processor to implement the response by routing the call to the identified agent.

In some implementations, the instructions further configure the processor to receive feedback about the routing from the identified agent, retrain the GenAI model based on execution of the GenAI model on the caller issue, the routing, and the feedback, and store the retrained GenAI model in the memory.

In another aspect of the present disclosure, there is provided a method comprising: storing a playbook of a call center in a memory; monitoring a call in real-time during the call with a caller; identifying, from the call, a caller issue in real-time using a trained machine learning model; obtaining a response to the caller issue based on execution of a generative artificial intelligence (GenAI) model and the playbook stored in the memory; and implementing the response during the call.

In a further aspect of the present disclosure, there is provided a computer-readable medium comprising instructions stored therein which, when executed by a processor, cause a computer to: store a playbook of a call center in a memory; monitor a call in real-time during the call with a caller; identify, from the call, a caller issue in real-time using a trained machine learning model; obtain a response to the caller issue based on execution of a generative artificial intelligence (GenAI) model and the playbook stored in the memory; and implement the response during the call.

The present subject matter uses trained machine learning models and generative AI to identify issues in customer calls, identify the relevant information within a repository of the call center's playbook, provide relevant playbook summaries, answers to queries customized to the caller, identify solutions to the caller issue within past call transcripts, and manage the call center queue, route calls, and the like. The models can be used to help provide more accurate and efficient responses to callers than is normally performed within a call center, and to reduce the computing processing resources otherwise required.

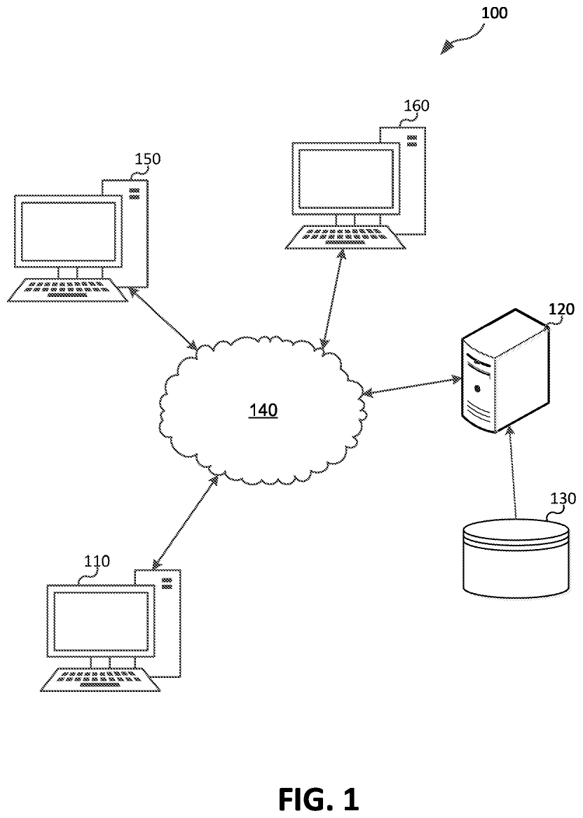

FIG. 1 is a schematic operation diagram illustrating an operating environment of an example embodiment of a contact or call center. As shown, the system 100 includes an agent device 110 and a server computer system 120 with a database 130, coupled to one another through a network 140, which may include a public network such as the Internet and/or a private network. The agent device 110 and the server computer system 120 may be in the same location or geographically disparate locations. In other words, the agent device 110 and the server computer system 120 may be located remote from one another. The system 100 may further include other agent devices 150 and 160, which may also be coupled the server computer system 120 through the network 140.

The agent device 110 may be a personal computer as shown in FIG. 1. However, the agent device 110 may be a computing device of another type such as for example a smartphone, a laptop, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. The agent device 110 may be associated with a user, such as a call agent of the call center.

The server computer system 120 may be, for example, a mainframe computer, a minicomputer, or the like. In some embodiments thereof, a computer system may be formed of or may include one or more computing devices. The server computer system 120 may include and/or may communicate with multiple computing devices such as, for example, one or more database servers (including a database 130), computer servers, and the like. Multiple computing devices such as these may be in communication using a computer network and may communicate to act in cooperation as a computer server system. For example, the computing devices may communicate using a local-area network (LAN). In some embodiments, the server computer system 120 may include multiple computing devices organized in a tiered arrangement. For example, the server computer system 120 may include middle tier and back-end computing devices. In some embodiments, the server computer system 120 may be a cluster formed of a plurality of interoperating computing devices.

The server computer system 120 may be associated with a call center used by one of various companies or institutions. In some embodiments, the server computer system 120 may be associated with a call center of a financial institution and, to that end, may maintain records of customer financial accounts and associated financial data in the database 130. The database 130 may be provided internally within the server computer system 120 or externally. To that end, the database 130 may be provided remotely from the server computer system 120. For example, the database 130 may be stored in one or more data centers, and the data centers may store data with bank-grade security.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components. In another embodiment, the system 100 may be a cloud-based system. For example, the server computer system 120 may itself be virtual and the various components and modules thereof may be resident on the cloud. The server computer system 120 may include one or more virtual machines or virtual processors that may be accessed via the cloud.

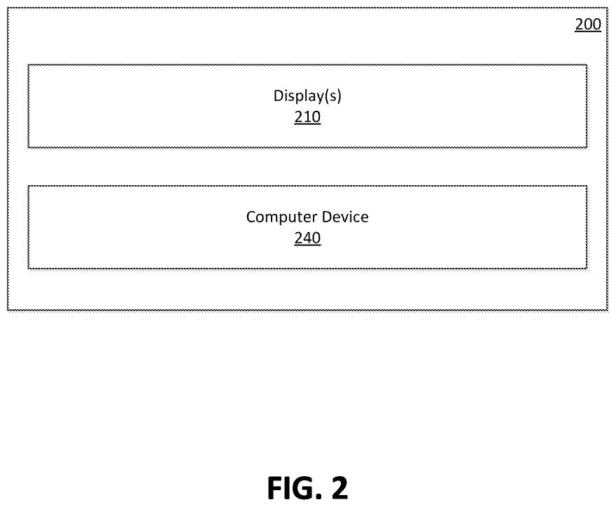

FIG. 2 is a simplified schematic diagram showing components of an exemplary computing device 200, such as the agent device 110, 150, 160. The exemplary computing device 200 may include modules including, as illustrated, for example, one or more displays 210 and a computer device 240.

The one or more displays 210 are a display module. The one or more displays 210 are used to display screens of a graphical user interface that may be used, for example, to communicate with the server computer system 120. The one or more displays 210 may be internal displays of the exemplary computing device 200 (e.g., disposed within a body of the computing device).

The computer device 240 is in communication with the one or more displays 210. The computer device 240 may be or may include a processor which is coupled to the one or more displays 210.

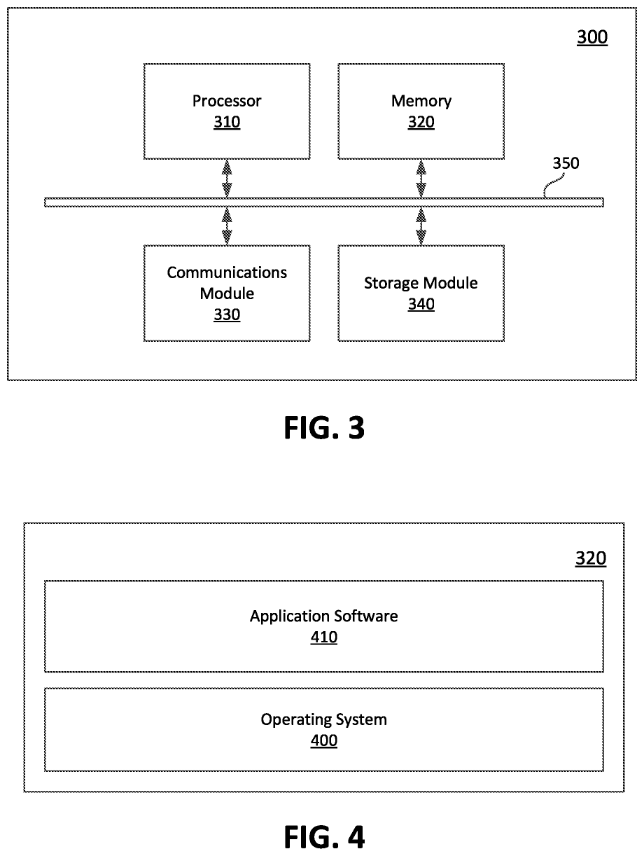

Referring now to FIG. 3, a high-level operation diagram of an example computer system 300 is shown. In some embodiments, the example computing system 300 may be exemplary of the server computer system 120 and/or the agent devices 110, 150, 160 (shown in FIG. 1). The example computer system 300 includes a variety of modules. For example, the example computer system 300 may include at least one processor 310, a memory 320, a communications module 330, and/or a storage module 340. As illustrated, the foregoing example modules of the example computer system 300 are in communication over a bus 350.

The at least one processor 310 is a hardware processor. The at least one processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are non-transitory computer-readable storage mediums. A computer-readable medium may be organized using a file system such as may be administered by an operating system governing overall operation of the example computer system 300.

The communications module 330 allows the example computer system 300 to communicate with other computer or computing devices and/or various communications networks. For example, the communications module 330 may allow the example computer system 300 to send or receive communications signals to/from the agent devices 110, 150, 160 over the network 140. Communications signals may be sent or received according to one or more protocols or according to one or more standards. For example, the communications module 330 may allow the example computing system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing system 300 to communicate using near-field communication (NFC), via Wi-Fi™, using Bluetooth™ or via some combination of one or more networks or protocols. In some embodiments, all or a portion of the communications module 330 may be integrated into a component of the example computing system 300. For example, the communications module 330 may be integrated into a communications chipset. In some embodiments, the communications module 330 may be omitted such as, for example, if sending and receiving communications is not required in a particular application.

The storage module 340 allows the example computing system 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as the database 130, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the at least one processor 310 in concert with the communications module 330 such as, for example, if data is stored remotely. The storage module may also be referred to as a data store.

Software comprising instructions is executed by the at least one processor 310 from a computer-readable medium. For example, software may be loaded into random-access memory from persistent storage of the memory 320. Additionally or alternatively, instructions may be executed by the at least one processor 310 directly from read-only memory of the memory 320.

FIG. 4 depicts a simplified organization of software components stored in the memory 320 of the example computing system 300 (FIG. 3). As illustrated, these software components include an operating system 400 and an application 410.

The operating system 400 is software. The operating system 400 allows the application 410 to access the at least one processor 310, the memory 320, and the communications module 330 of the example computing system 300 (FIG. 3). The operating system 400 may be, for example, Google™ Android™, Apple™ iOS™, UNIX™, Linux™, Microsoft™ Windows™, Apple OSX™ or the like.

The application 410 adapts the example computing system 300, in combination with the operating system 400, to operate as a device performing a particular function. For example, the application 410 may cooperate with the operating system 400 to adapt a suitable embodiment of the example computing system 300 to operate as the server computing system 120 and/or the agent devices 110, 150, 160 (FIG. 1).

While a single application 410 is illustrated in FIG. 4, in operation, the memory 320 may include more than one application 410 and different applications may perform different operations. For example, in at least some embodiments in which the example computing system 300 is functioning as the agent device 110, 150, 160, the applications 410 may include an application for displaying a graphical user interface associated with sending an application programming interface request. The server computer system 120 may be configured to receive application programming interface requests and may perform operations to respond thereto.

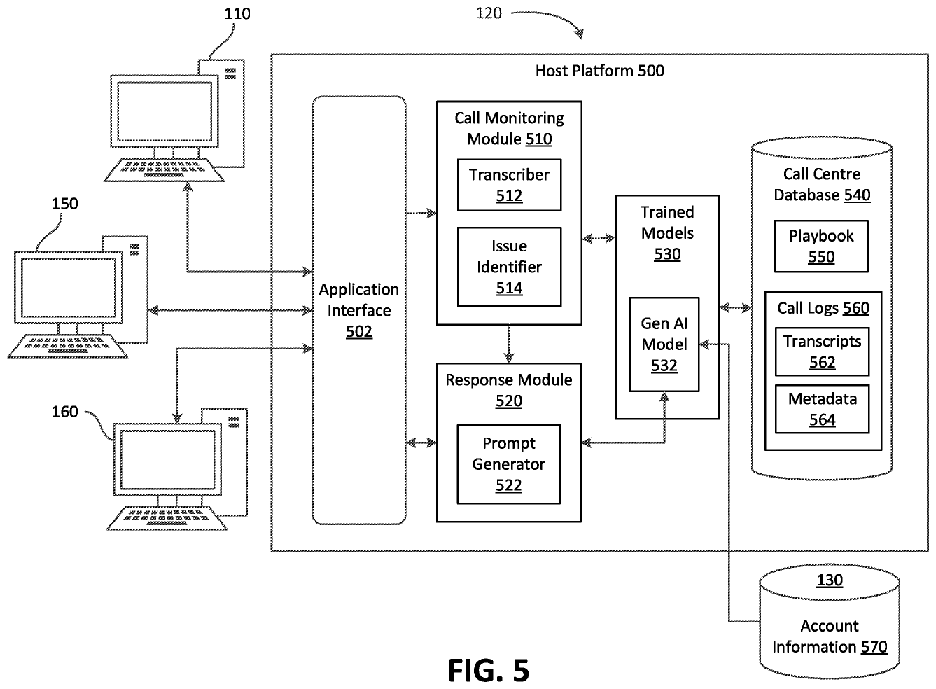

FIG. 5 is a simplified schematic diagram showing components of a host platform 500 of the server computer system 120 in greater detail and the database 130. The server computer system 120 may store computer-executable instructions in the memory 320, which may be executed by a processing unit such as the processor 310, to implement one or more embodiments disclosed herein. The depicted example embodiments are directed to the server computer system 120 that hosts the host platform 500 that uses trained machine learning (ML) models, including generative artificial intelligence (GenAI), to enhance operations of a contact center or call center. The host platform 500 may receive input from a user, such as a call center agent and/or a caller through agent devices 110, 150, 160 where the input may be a text input, a document, or speech that is then converted into text and the like, and respond with an answer to the input. Here, one or more trained ML models, including a generative artificial intelligence (GenAI) model, may receive the input from the user and generate an answer based on its/their training. The response may include a text-based description, an image, a combination thereof, call routing, management of call queues, and the like.

The memory 320 of the server computer system 120 may store instructions for implementing software applications hosted by the host platform 500, including an application interface 502, a call monitoring module 510, a response module 520, trained models 530, and data storage containing call center database 540.

In the depicted example, the host platform 500 may be a cloud platform, web server, etc., that hosts software applications and other software programs that are hosted and made available on the Internet to the agent devices 110, 150, 160. The software may be accessed via a URL, mobile application, etc. In other examples, the call monitoring module 510 and the response module 520 may reside in the memory 320 of the agent devices 110, 150, 160 while the trained models 530 and the call center database 540 may reside in the memory 320 of the server computer system 120. Other variations are possible.

In any case, the application interface 502 may act as a software intermediary that allows an application executing on the agent device 110, 150, 160 to communicate with an application executing on the server computer system 120. The application interface 502 may allow the agent device 110 to request data and may enable the server computer system 120 to obtain and provide the requested data to the agent device 110.

The application interface 502 may be configured to receive application programming interface requests that define parameters. The application interface 502 may perform operations to obtain data to fulfill the application programming interface requests.

In one or more embodiments, the application interface 502 may include a representational state transfer (REST) application programming interface. The REST application programming interface may utilize Hypertext Transfer Protocol (HTTP) methods (e.g. GET, POST) to receive and respond to application programming interface requests. The REST application programming interface may obtain data according to application programming interface requests and may return fixed data sets as a response to the application programming interface requests.

In one or more embodiments, the application interface 502 may include a GraphQL application programming interface. The GraphQL application programming interface may be hierarchical. The GraphQL application programming interface may obtain data according to application programming interface requests without under fetching or over fetching data.

The application interface 502 may include both the REST application programming interface and the GraphQL schemas and may perform operations to select one of the REST and GraphQl application programming interfaces. In one or more embodiments, the server computer system 120 may receive an application programming interface request in a format compliant with one of the application programming interface schemas and may translate the request into another format.

The call monitoring module 510 comprises instructions to the processor 310 to monitor calls placed or directed to the agent device 110, 150, 160 and to identify one or more issues of the call in real-time during the call. To that end, the call monitoring module 510 may comprise a transcriber 512 and an issue identifier 514. The transcriber 512 may be a speech-to-text application as known in the art that is configured to automatically convert the verbal/audio content of the call into a text format during the call. The transcriber 512 may be a software tool and/or a machine learning model trained to convert audio into a transcript in real-time.

The issue identifier 514 may be, or may comprise, another machine learning model that has been trained to identify one or more caller issues from the call. To that end, the issue identifier 514 may be trained to identify the caller issue from the audio portion of the call or from the transcript of the call (as transcribed by the transcriber 512). The issue identifier 514 may be, for example, a trained neural network, a trained deep neural network (DNN), or a trained convolutional neural network (CNN). The issue identifier 514 may have been trained using a training dataset of audio calls and/or transcripts that have been labelled with ground-truth caller issue keywords. In that manner, the issue identifier 514 may be a large language model (LLM) (discussed below) that uses natural language processing techniques to extract the one or more caller issues from the call. These models may be stored in the memory 320 of the server computer system 120 as the trained models 530, or may be stored and accessed remotely (not shown).

While the machine trained models described above may be specifically trained to transcribe an audio call and/or identify one or more caller issues from the call, in other applications, those (and other) functions may be performed by a foundational model, such as a refined or trained generative artificial intelligence (GenAI) model.

The response module 520 comprises instructions to the processor 310 to generate a response to be implemented by the call center in view of the one or more caller issues identified by the call monitoring module 510. To that end, the response module 520 may be or may use a generative artificial intelligence (GenAI) model to generate a response. In the example embodiments, the host platform 500 may include one or more trained machine learning models, including GenAI model 532, which is capable of receiving prompts and generating call center responses to the prompts. A prompt is typically understood to be a natural language input that includes instructions to the LLM/GenAI model to generate a desired output. The GenAI model 532 may be held by the host platform 500 within a model repository as one of the trained models 530, or held and accessed remotely from a cloud.

According to various embodiments, the GenAI model 532 may be a large language model (LLM), such as a multimodal large language model. As another example, the GenAI model may be a transformer neural network (“transformer”) or the like. A language model may use a neural network (typically a DNN) to perform natural language processing (NLP) tasks such as language translation, image captioning, grammatical error correction and natural language generation, among others. A language model may be trained to learn parameters in order to model how words relate to each other in a textual sequence, based on probabilities. A language model may contain hundreds of thousands of learned parameters or in the case of a large language model (LLM) may contain millions or billions of learned parameters or more. In that manner, the GenAI model can learn the patterns and structure of their input training data and then generate new content that has similar characteristics.

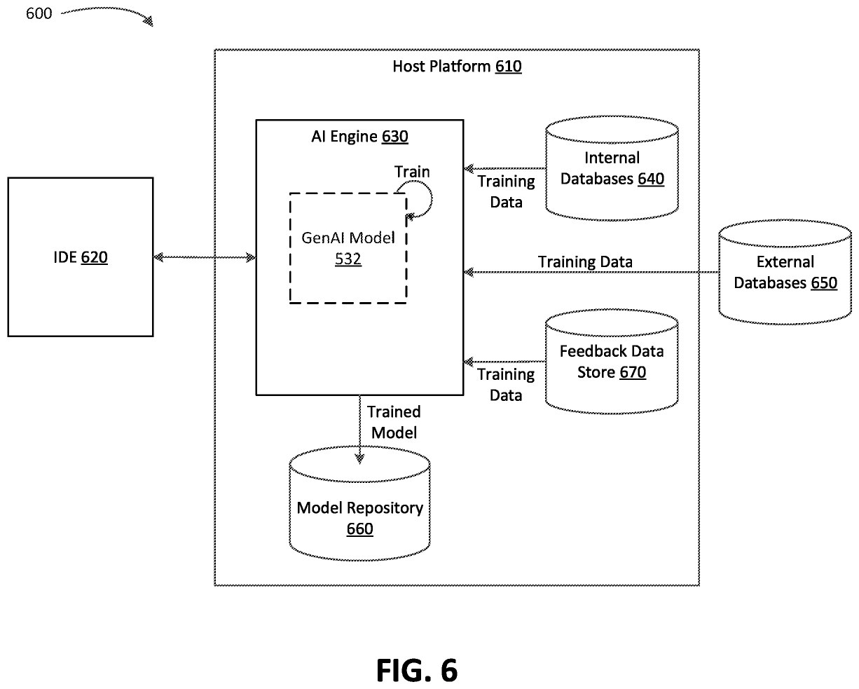

FIG. 6 schematically illustrates a process 600 of training the parameters of the GenAI model 532 according to example embodiments. However, it should be appreciated that the process 600 is also applicable to other types of models, such as other machine learning models, AI models, and the like. Referring to FIG. 6, a host platform 610 may host an IDE 620 (integrated development environment) where GenAI models, machine learning models, AI models, and the like may be developed, trained, retrained, and the like. In this example, the IDE 620 may include a software application with a user interface accessible by a user device over a network or through a local connection.

For example, the IDE 620 may be embodied as a web application that can be accessed at a network address, URL, etc., by a device. As another example, the IDE 620 may be locally or remotely installed on a computing device used by a user.

The IDE 620 may be used to design a model (via a user interface of the IDE), such as a generative artificial intelligence model that can receive audio and/or text as input and generate custom responses for the call center, etc. The model can then be executed/trained based on training data established via the user interface. During training, the GenAI model 532 may be executed on training data via an AI engine 630 of the host platform 610.

The GenAI model 532 may be trained to understand playbooks of call centers, natural language conversations, and the like based on a large corpus of documentation. The training data may be provided from a training data store such as an internal database 640, which may include training samples from the web, from customers, and the like. Additionally or alternatively, the training data may be pulled from one or more external databases 650 such as publicly available sites, etc.

In some implementations, the GenAI model 532 may be trained with web pages, various playbooks and operation manuals of call centers, audio and/or transcripts of past calls to call centers, documentation, and other data about the operation of call centers. The GenAI model 532 may also be trained with content gathered by web page scrapers or crawlers from website pages comprising call center best practices, recommendations, and frequently asked question (FAQ) resources, and/or to fetch them from repositories or storage. The GenAI model 532 may further be trained with data from forum discussions, Q&A platforms, user reviews, customer satisfaction surveys, and other data sources that provide insight into the call center.

In some embodiments, the payload of data may be in a format that is not capable of being input to the GenAI model 532 nor read by a computer processor. For example, the payload of data may be in text format, image format, audio format, and the like. In response, the AI engine 630 may convert the payload of data into a format that is readable by the GenAI model 532, such as a vector or other encoding. The vector may then be input to the GenAI model 532.

The AI engine 630 may iteratively retrieve additional training data sets from the internal and external databases 640, 650 and iteratively input the additional training data sets into the GenAI model 532 during the execution of the model to continue to train the model. The AI engine 630 may continue the process until it receives instructions to terminate, which may be based on a number of iterations (training loops), total time elapsed during the training process, etc.

When the GenAI model 532 is sufficiently trained, it may be stored within a model repository 660 as one of the trained models 530 via the IDE 620 or the like.

The IDE 620 may also be used to retrain the GenAI model 532 after the model has been deployed. Here, the training process may use executional results that have already been generated or output by the GenAI model 532 in a live environment (including any agent or caller feedback, etc.) to retrain the GenAI model 532. For example, responses that are generated by the GenAI model 532 and the caller/agent/user feedback of the responses may be used to retrain the model to further enhance the responses that are generated for all users. The feedback may include indications of whether the generated responses match, are liked, and/or are relevant to the caller issue, and, if not, what aspects of the response are incorrect. This feedback data may be captured and stored within a feedback data store 670 or other data store within the live environment and can be subsequently used to retrain the GenAI model 532.

Returning to FIG. 5, the response module 520 comprises instructions to the processor 310 to execute the trained GenAI model 532 to generate a response to the one or more caller issues (identified by the call monitoring module 510) to be implemented by the call center in real-time during the call. The response may be to summarize the relevant information within a repository of the call center's playbook, provide answers to queries customized to the caller, identify solutions to the caller issue within past call transcripts, manage the call center queue, route calls to a particular agent, and other similar call center features. In some implementations, the desired output for the GenAI model 532 may be pre-set or predetermined. Alternatively, the response module 520 may also comprise instructions to the processor 310 to receive an indication from the agent device 110 regarding what the agent's desired output from the GenAI model 532 is or may be.

The host platform 500 may further host a call center database 540 containing the call center's current playbook 550 and call logs 560. The call logs 560 may include transcripts 562 of prior calls made to the call center and metadata 564 associated with the prior calls and transcripts 562. The prior call transcripts 562 may be verbatim or shorthand transcription of the conversation between the caller and the agent, and may include other call content data, including the caller issues, whether the issue(s) were resolved, how the issue(s) was resolved etc. The metadata 564 may include the date and time of call, the call duration, the wait time, the identity of the caller, the identity of the agent(s), and customer satisfaction feedback etc.

The host platform 500 may further host the database 130 or the database 130 may be provided remotely from the server computer system 120 (depicted in FIG. 5). As noted above, in some embodiments, the server computer system 120 may be associated with a call center of a financial institution and, to that end, may maintain records of customer financial accounts and associated financial data in the database 130 as account information 570.

According to various embodiments, to generate a response, the GenAI model 532 may be executed using custom-defined prompts that may be designed to first identify the caller issue (via the call monitoring module 510), and then to generate a customized response related to the caller issue as noted above in view of the call center playbook, past calls, account information, or the like. In other embodiments, a separate prompt may be designed to perform each of those functions. In the depicted embodiment, the response module 520 may comprise a prompt generator 522 for generating prompts to the GenAI model 532, such as to generate the customized response related to the caller issue in view of the call center playbook, past calls, account information etc.

Prompt engineering is the process of structing sentences (prompts) so that they are understood by the GenAI model. Part of the prompting process may include delays/waiting times that are intentionally included within the script such that the model has time to think/understand the input data.

The prompt generator 522 may comprise instructions to the processor 310 to generate a prompt to the GenAI model 532 (with the identified caller issue and with reference to the playbook 550) to generate a number of different outputs. In some implementations, the desired output from the GenAI model 532 may be pre-set or predetermined. Alternatively, a signal regarding the desired output from the GenAI model 532 may be previously received by the processor 310 from the agent device 110. In either case, the prompt may also be generated with the pre-set or indicated desired output specified. The response module 520 further comprises instructions to the processor 310 to implement the response (based on the generated output) during the call. For example, implementation of the response may include providing the output from the GenAI model 532 on a user interface of the agent device 110, such as on the display 210.

In some implementations, the prompt generator 522 may comprise instructions to the processor 310 to generate a prompt for generating a summary of a portion of the playbook 550 related to the caller issue. The summary generated by the GenAI model 532 may then be implemented when the response module 520 instructs the processor 310 to provide the summary output to the requesting agent via the user interface, such as to be displayed on the display 210 of the agent device 110 in real-time during the call. This saves on processing power, as the agent no longer has to search through the playbook for the relevant portions, and reduces response time as the agent no longer has to search for and review the content before responding to the caller.

In other implementations, the prompt generator 522 may comprise instructions to the processor 310 to receive an authorization regarding an identity of the caller from the agent device 110. To that end, the memory of the agent device 110 may comprise instructions to implement an authorization protocol with the caller during the call. The prompt generator 522 may comprise instructions to the processor 310 to generate a prompt that further incorporates the account information 570 or includes reference to the account information 570 (such as may be stored in the database 130 of the server computer system 120) associated with the identity of the caller.

In some implementations, when the caller issue is in a form of a question, the generated prompt may be for generating a reply based on the playbook 550 customized according to the account information 570. The reply generated by the GenAI model 532 may then be implemented when the response module 520 instructs the processor 310 to provide the reply output to the requesting agent via the user interface, such as to be displayed on the display 210 of the agent device 110 in real-time during the call. This saves on processing power, as the agent no longer has to search through the caller's account information, and reduces response time as the agent no longer has to search for and review the caller's account information before responding to the caller.

As noted above, the host platform 500 may host the call center database 540 containing the call center's current playbook 550 and call logs 560 comprising transcripts 562 of prior calls and metadata 564 associated with the prior call transcripts 562. In other implementations, the prompt generator 522 may comprise instructions to the processor 310 to generate a prompt for identifying the caller issue (as identified by the monitoring module 510) in one of the prior call transcripts 562, and for identifying a solution to the caller issue in the identified prior call transcript 562. The solution generated by the GenAI model 532 may then be implemented when the response module 520 instructs the processor 310 to provide the solution output to the requesting agent via the user interface, such as to be displayed on the display 210 of the agent device 110 in real-time during the call. This saves on processing power, as the agent does not have to search through all of the prior call transcripts 562 for the caller issue and associated solution, and reduces response time.

If the GenAI model 532 is an LLM, the prompts and the summary and the reply outputs may be in a natural language format.

The response module 520 may further have instructions to the processor 310 to ask for, and receive, feedback from the agent about the output generated by the GenAI model 532 (such as the summary, the reply, the solution etc.) via the user interface. As noted above, this feedback data may be captured and stored within the feedback data store 670 or other data store within the live environment and can be subsequently used to retrain the GenAI model 532. The retrained GenAI model may be stored in the memory 320 with the other trained models 530.

As noted above, the call logs 560 of the call center database 540 may include transcripts 562 of prior calls and metadata 564 associated with the prior call transcripts 562. The metadata 564 may include the date and time of call, the call duration, the wait time, the identity of the caller, the identity of the agent(s), and customer satisfaction feedback etc. In view of the call logs 560, the prompt generator 522 may also comprise instructions to the processor 310 to generate a prompt to the GenAI model 532 to generate other outputs that may be implemented by the processor 310 as the response in the following ways.

In some implementations, the prompt generator 522 may comprise instructions to the processor 310 to generate a prompt that further includes a reference to the call logs 560. The prompt may be generated for identifying the caller issue (as identified by the monitoring module 510) in one of the prior call transcripts 562, and for identifying the call duration of the prior call of the identified prior call transcripts 562. Thus, the output from the GenAI model 532 may comprise an expected call duration of the current call based on the call duration of the prior call of the identified prior call transcripts. The response module 520 may have further instructions to the processor 310 to implement the response by placing the current call in a call queue according to the expected call duration. In some implementations, the prompt generator 522 may comprise instructions to the processor 310 to receive authorization regarding the identity of the caller from the agent device 110. The prompt generator 522 may then further comprise instructions to the processor 310 to generate the prompt which includes reference to the account information 570 (such as may be stored in the database 130 of the server computer system 120) associated with the identity of the caller. The expected call duration generated by the GenAI model 532 may then be further based on the account information 570 of the caller. In that manner, a call queue of the call center may be managed based on the expected call durations of different live calls.

In other implementations, the response module 520 may comprise instructions to the processor 310 to implement the response by routing the call to a particular agent based on the output from the GenAI model 532. To that end, the prompt generator 522 may comprise instructions to the processor 310 to generate a prompt that further includes a reference to the call logs 560. The prompt may be generated for identifying the current caller issue (as identified by the monitoring module 510) in one of the prior call transcripts 562, and for identifying the agent associated with the prior call of the identified prior call transcript 562. This helps to identify an agent who has dealt with the current caller issue in the past, as evidenced by the prior call transcript 562. Thus, the output from the GenAI model 532 may comprise the identification of the agent associated with the prior call of the identified prior call transcript. The response module 520 may have further instructions to the processor 310 to implement the response by routing the call to the identified agent. This may help to save on processing power, as a more inexperienced agent may not have to search through all of the prior call transcripts 562 and/or the playbook 550 in order to find the caller issue and associated solution, or may help to save on processing power as this may help to prevent an inexperienced agent from having to try potentially ineffective solutions before arriving at an effective one. This may also help to reduce response time.

The response module 520 may further have instructions to the processor 310 to ask for, and receive, feedback from the identified agent about the routing via the user interface. As noted above, this feedback data may be captured and stored within the feedback data store 670 or other data store within the live environment and can be subsequently used to retrain the GenAI model 532. The retrained GenAI model may be stored in the memory 320 with the other trained models 530.

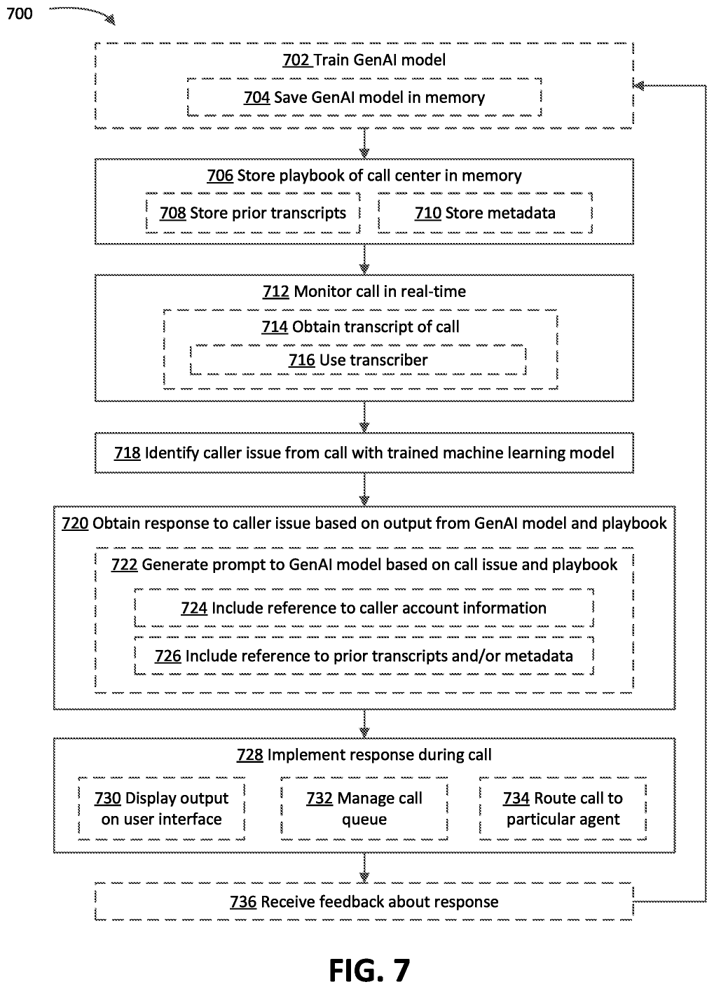

Reference will now be made to FIG. 7, which shows, in flowchart form, an example method 700 of enhancing call center features based on the call center's playbook according to example embodiments. The method 700 may be implemented by way of suitably programmed processor-executable instructions stored in memory that, when executed, cause a computing device to carry out the described functions as described above. As other examples, the method 700 may be performed by another computing system, a software application, a server, a cloud platform, a combination of systems, and the like.

At operation 702, the method 700 may include training the GenAI model. The GenAI model may be a new or existing foundational model refined or trained to understand playbooks of call centers, natural language conversations, and the like based on a large corpus of documentation. The training data may be provided from a training data store, which may include training samples from the web, from customers, and the like. Additionally or alternatively, the training data may be pulled from one or more external databases, such as publicly available sites, etc. The GenAI model may be trained with web pages, various playbooks and operation manuals of call centers, audio and/or transcripts of past calls to call centers, documentation, and other data about the operation of call centers. The GenAI model may also be trained with content gathered by web page scrapers or crawlers from website pages comprising call center best practices, recommendations, and frequently asked question (FAQ) resources, and/or to fetch them from repositories or storage. The GenAI model may further be trained with data from forum discussions, Q&A platforms, user reviews, customer satisfaction surveys, and other data sources that provide insight into the operations of the call center.

The customized GenAI model may then be stored (in memory) at operation 704. Other trained machine learning models may also be stored in memory, including a speech-to-text model and/or a machine learning model that has been trained to identify one or more caller issues from the call (such as the issue identifier discussed above). This model may be a trained neural network, a trained deep neural network (DNN), or a trained convolutional neural network (CNN) trained on training datasets of audio calls and/or transcripts that have been labelled with ground-truth caller issue keywords. In that manner, it may be a large language model that uses natural language processing (NLP) techniques to extract one or more caller issues from the call.

At operation 706, the playbook of the call center may also be stored in memory or a database, along with, optionally, prior versions of the playbook, call transcriptions or audio files of prior calls to the call center (at operation 708) and associated metadata (at operation 710). The transcripts of prior calls made to the call center may be verbatim or shorthand transcription of the conversation between the caller and agent, and may include other call content data, including the caller issues, whether the issue(s) were resolved, how the issue(s) was resolved etc. The metadata may include the date and time of call, the call duration, the wait time, the identity of the caller, the identity of the agent(s), and customer satisfaction feedback etc.

At operation 712, a call between the caller and the call center agent is monitored in real-time, such as may be performed by the call monitoring module described above. The call may be monitored and recorded as an audio file. Alternatively or additionally, a transcript of the call may be obtained at operation 714 in real-time during the call with the caller. The transcript may be obtained using a speech-to-text tool, such as a transcriber (at operation 716). The transcriber may be a software application, such as the speech-to-text model stored at operation 704. Alternatively, the transcriber may be stored remotely and accessed as needed.

At operation 718, the method 700 further includes identifying, from the call or transcript, a caller issue in real-time using the same or another trained machine learning model, such as the issue identifier discussed above. This machine learning model may have been trained using a training dataset of audio calls and/or transcripts that have been labelled with ground-truth caller issue keywords. In that manner, the issue identifier may be an LLM that uses natural language processing techniques to extract the one or more caller issues from the call. The issue identifier used may have been stored locally at operation 704. Alternatively, the issue identifier may be stored remotely and accessed as needed.

At operation 720, a response to the caller issue is obtained based on execution of the GenAI model and the playbook stored in memory to generate an output. In order to execute the GenAI model, a prompt may be generated based on the identified caller issue and the playbook at operation 722, such as by the prompt generator discussed above. A prompt is typically a natural language input that includes instructions to the LLM/GenAI model to generate a desired output.

The desired output may be pre-set or predetermined. Alternatively, the method 700 may also include receiving an indication from the agent device regarding the agent's desired output from the GenAI model 532 prior to generating the prompt.

For example, if the desired output is a summary of a portion of the playbook related to the caller issue, the prompt may be engineered and generated for that purpose, and the output would include a summary of the playbook related to the caller issue.

In other implementations, if the desired output involves output customized to a caller's personal account information, at operation 724, the prompt may be generated to incorporate account data or information associated with the caller. For example, if the call center was associated with a financial institution, the account data may be the banking or financial information of the caller's account with the financial institution. In some implementations, the account information may be retrieved from memory and incorporated in the prompt. Alternatively, the prompt may be generated to link or refer to the account information stored remotely. Prior to operation 724, authorization regarding an identity of the caller may be received prior to the caller's account information being incorporated into, or referred to in, the prompt. For example, if the caller issue is in a form of a question, the prompt may generated to output a reply based on the playbook customized according to the caller's account information.

If the desired output relates to content from prior calls to the call center, at operation 726, the prompt may be generated to identify or reference call transcriptions or audio files of prior calls to the call center (saved at operation 708). For example, if the desired output is a solution to the current caller issue that was implemented in a past call, the prompt may be engineered and generated to identify the current caller issue in one of the prior call transcripts, and to identify the associated solution. The output would then include the solution from the prior call.

If the desired output relates to parameters or metadata associated with prior calls to the call center, at operation 726, the prompt may also be generated to identify or reference metadata associated with the transcripts or audio files of prior calls to the call center (saved at operation 710). For example, if the desired output is an expected call duration of the current call, the prompt may be engineered and generated to identify the current caller issue in one of the prior call transcripts (or audio files), and to identify the call duration of the prior call from the associated metadata. The output would then include the expected call duration of the current call. If authorization regarding the identity of the caller was received, the caller's account information may also be incorporated into, or be referred to in, the prompt. Thus, the output may then include the expected call duration of the current call for the particular caller.

In other implementations, if the desired output is an identity of an agent who has handled the current caller issue before at the call center, the prompt may be engineered and generated to identify the current caller issue in one of the prior call transcripts, and to identify the agent associated with the prior call. Thus, the output from the GenAI model 532 may comprise the identification of the agent associated with the prior call of the identified prior call transcript. The output would then include the identity of the agent who has handled the current caller issue before at the call center.

The response to the caller issue, then, may be based on the above-described output from the GenAI model, and the response implemented at operation 728 in real-time during the call.

Implementation of the response would depend on the output generated by the GenAI model. For example, if the output is a summary of the playbook related to the caller issue, an answer to a question customized to the caller's account information, or a solution to the caller issue used in a prior call, at operation 730, the implementation may involve displaying the output to the agent on a user interface during the call. If the output is an expected call duration for the current call, at operation 732, the implementation may involve placing the current call in a call queue according to the expected call duration. In that manner, a call queue of the call center may be managed based on the expected call durations of different live calls. If the output is an identity of an agent who has handled the current caller issue before, at operation 734, the implementation may involve routing the current call to the identified agent.

At operation 736, feedback may be received from the agent about the output generated by the GenAI model (such as the summary, the reply, the solution, the routing etc.) via the user interface. This feedback data may be captured and stored in memory or other data store and can be subsequently used to retrain the GenAI model at operation 702. The retrained GenAI model may be stored in the memory at operation 704 with the other trained models.

The presently described systems and methods may help an agent respond more accurately and consistently to caller issues in relation to the call center's playbook, without extensive and time-consuming searching of the playbook and prior call transcripts or resorting to imperfect recollection. The presently described systems and methods may also help the call center manage live calls by more effectively ordering call queues and routing callers to an experienced or appropriate agent, who can more quickly resolve the caller issue. This may help to save on processing power, as it may help prevent overlap of the same searching of the playbook and/or prior call transcripts when multiple agents encounter the same caller issue.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system, comprising:
a processor;
a communications module coupled to the processor; and
a memory coupled to the processor, the memory storing a playbook of a call center and instructions that, when executed, configure the processor to:
monitor a call in real-time during the call with a caller;
identify, from the call, a caller issue in real-time using a trained machine learning model;
obtain a response to the caller issue based on execution of a generative artificial intelligence (GenAI) model and the playbook stored in the memory; and
implement the response during the call.

2. The system of claim 1, wherein the instructions, when executed, further configure the processor to: obtain a transcript of the call in real-time during the call, and identify the caller issue from the transcript of the call.

3. The system of claim 2, further comprising a transcriber coupled to the processor, wherein the transcript of the call is obtained by the transcriber.

4. The system of claim 1, wherein the instructions, when executed, further configure the processor to train the GenAI model with other call center playbooks prior to the call.

5. The system of claim 3, wherein the GenAI model is a large language model (LLM).

6. The system of claim 5, wherein the instructions, when executed, further configure the processor to:
obtain the response by:
generating a prompt to the LLM, the prompt including the caller issue with reference to the playbook; and
obtain an output from the LLM responsive to the prompt; and
implement the response by providing the output via a user interface.

7. The system of claim 6, wherein the output comprises a summary of a portion of the playbook related to the caller issue, and the prompt to the LLM is for generating the summary as the output.

8. The system of claim 6, wherein the instructions, when executed, further configure the processor to receive an authorization regarding an identity of the caller from an agent device.

9. The system of claim 8, wherein the prompt further includes reference to account information associated with the identity of the caller.

10. The system of claim 9, wherein the caller issue is a form of a question, the output comprises a reply to the question, and the prompt to the LLM is for generating the reply based on the playbook customized according to the account information.

11. The system of claim 6, wherein the memory further stores prior call transcripts of the call center, wherein the prompt to the LLM is for identifying:
the caller issue in one of the prior call transcripts, and
a solution to the caller issue in the one of the prior call transcripts; and
wherein the output comprises the solution.

12. The system of claim 11, wherein the instructions, when executed, further configure the processor to receive feedback about the solution via the user interface, retrain the GenAI model based on execution of the GenAI model on the caller issue, the solution, and the feedback, and store the retrained GenAI model in the memory.

13. The system of claim 2, wherein the memory further stores call log data of the call center, the call log data comprising prior call transcripts of prior calls and metadata associated with the prior calls, wherein the instructions, when executed, further configure the processor to:
obtain the response by:
generating a prompt to the GenAI model, the prompt including the caller issue with reference to the playbook and the call log data, and
obtain an output from the GenAI model responsive to the prompt; and
implement the response based on the output.

14. The system of claim 13, wherein the metadata comprises a call duration of each of the prior calls, wherein the prompt to the GenAI model is for identifying:
the caller issue in one of the prior call transcripts, and
the call duration of the prior call of the one of the prior call transcripts;
wherein the output comprises an expected call duration of the call based on the call duration of the prior call of the one of the prior call transcripts; and
wherein the instructions, when executed, further configure the processor to implement the response by placing the call in a call queue according to the expected call duration.

15. The system of claim 14, wherein the prompt further includes account information associated with an identity of the caller, and wherein the expected call duration is further based on the account information of the caller.

16. The system of claim 13, wherein the instructions, when executed, further configure the processor to implement the response by routing the call to a particular agent based on the output.

17. The system of claim 13, wherein the metadata comprises identification of an agent associated each of the prior calls, wherein the prompt to the GenAI model is for identifying:
the caller issue in one of the prior call transcripts, and
the agent associated with the prior call of the one of the prior call transcripts;
wherein the output comprises the identification of the agent associated with the prior call of the one of the prior call transcripts; and
wherein the instructions, when executed, further configure the processor to implement the response by routing the call to the identified agent.

18. The system of claim 17, wherein the instructions, when executed, further configure the processor to receive feedback about the routing from the identified agent, retrain the GenAI model based on execution of the GenAI model on the caller issue, the routing, and the feedback, and store the retrained GenAI model in the memory.

19. A method comprising:
storing a playbook of a call center in a memory;
monitoring a call in real-time during the call with a caller;
identifying, from the call, a caller issue in real-time using a trained machine learning model;
obtaining a response to the caller issue based on execution of a generative artificial intelligence (GenAI) model and the playbook stored in the memory; and
implementing the response during the call.

20. A computer-readable medium comprising instructions stored therein which, when executed by a processor, cause a computer to:
store a playbook of a call center in a memory;
monitor a call in real-time during the call with a caller;
identify, from the call, a caller issue in real-time using a trained machine learning model;
obtain a response to the caller issue based on execution of a generative artificial intelligence (GenAI) model and the playbook stored in the memory; and
implement the response during the call.
